(19) United States
(12) Patent Application Publication
(10) Pub. No.: US 2011/0094597 A1
(43) Pub. Date: Apr. 28, 2011

(54) HYDRAULIC CIRCUIT FOR A MACHINE FOR PRODUCING BEVERAGES BY INFUSION

(75) Inventor: Jean-Pierre Blanc, Nice (FR)

(73) Assignee: COMPAGNIE MEDITERRANEENNE DES CAFES S.A., Carros (FR)

(21) Appl. No.: 12/674,823

(22) PCT Filed: Aug. 20, 2008
(86) PCT No.: PCT/EP08/60895

§ 371 Date: Jan. 7, 2011

(30) Foreign Application Priority Data
Aug. 24, 2007 (FR) 07 57165

(51) Int. Cl. F17D 1/00; A47J 31/46

(52) U.S. Cl. 137/14; 99/302 R

(57) ABSTRACT

A hydraulic circuit (1) for use on machines for making beverages includes a pump (3), a boiler (4) and an infusion chamber (5), the pump (3) being arranged so as to pressurize a liquid contained in a section of the circuit between the pump (3) and the infusion chamber (5) and including boiler (4). The circuit includes a depressurizing device (10) to allow a portion of the liquid to be discharged outside the section on liquid depressurization, the depressurizing device (10) being arranged so that the portion of the liquid does not come into contact with the boiler (4) when pressurizing the liquid.

The present invention concerns a hydraulic circuit for use on beverage-making machines.

It will be more especially used in the field of machines for making beverages by infusing a product in a pressurised liquid, for example ESPRESSO-type coffee machines. It may also be used to make other beverages such as tea or chocolate drinks that require the pressurisation of a liquid.

For the purposes of clarity, the term “machine” in the present application designates all machines used to prepare drinks by infusing a product in a pressurised liquid.

It is well-known that this type of machine comprises a hydraulic circuit incorporating a boiler for heating the water used to infuse products such as coffee, a water tank and an infusion chamber destined to receive the said product and allow its infusion by water.

Thus, water is stored in a tank before its temperature is increased in a boiler prior to its injection into an infusion chamber.

Moreover, so that the infusion can take place under pressure, this type of machine is equipped with a pump supplying the infusion chamber with water at pressure.

This pump is fitted between the tank and the boiler.

On ESPRESSO-type coffee machines, the coffee infuses at a pressure of around 8 to 12 bars. To achieve this level of pressure in the infusion chamber, the pump has to generate a pressure that is sufficiently high to compensate for head losses, the latter being considerable when passing through the boiler. Thus, the pump generally has to deliver a pressure of around 16 bars.

When making the beverage, high pressure builds up in all the hydraulic circuit between the pump and the infusion chamber.

Once the process of infusing the coffee comes to an end, the pressure of the hydraulic circuit has to be brought down to a level that is close to atmospheric pressure so that the infusion chamber can be opened and the infused product removed. On a machine designed to receive a packaged pod of product, this operation consists in removing the pod from the infusion chamber.

Failure to depressurise the infusion chamber beforehand would lead to a sudden projection of water and infused product such as ground coffee. This would often be accompanied by steam. These projections constitute an unacceptably hazard for the operator of the machine. Therefore it is vital to de-pressurised the hydraulic circuit once the product has been infused.

In order to depressurise the hydraulic circuit, a widely used method consists in allowing the discharged hot water and steam to stand in a condenser during depressurisation. The cold water produced by the condenser is then collected in a recipient called a “bassinelle”, also named liquid collector.

However, this arrangement has many shortcomings. Indeed, the user has to ensure that the “bassinelle” is emptied to avoid the collected water overflowing. Furthermore, the water that accumulates in the “bassinelle” stagnates leading to unpleasant smells, discolouring due to the growth of algae, and so on.

Certain machines also generate large quantities of discharged water is meaning that the “bassinelle” has to be frequently emptied. Moreover, if the temperature of the water in the condenser remained high, there would be a substantial increase in the temperature of the “bassinelle”, making it difficult to handle.

Another solution has been put forward that consists in discharging the excess water into the cold water tank. This solution also has its shortcomings. Indeed, when the machine is used frequently, a significant quantity of hot water is injected into the tank and this tends to a progressive increase of the temperature of the tank water. This increase in temperature can lead to microbial proliferation making the tank water unsuitable for human consumption.

The present invention aims to eliminate at least certain of the shortcomings noted in the above methods.

To achieve this, the present invention consists of a hydraulic circuit for use on machines for making beverages comprising the pump, the boiler and the infusion chamber, the pump being arranged so as to pressurize a liquid contained in a section of the circuit between the pump and the infusion chamber and including the boiler, the circuit including depressurising device to allow a portion of the liquid discharged outside the said section on depressurisation the liquid, the depressurising device being arranged so that the said portion of the liquid does not come into contact with the boiler when pressurising the liquid.

Thus, the temperature of the portion of liquid discharged during depressurisation does not rise. Consequently, this portion of the liquid can be stored without this increasing the temperature of the storage recipient and microbial proliferation inside the latter.

The circuit according to the invention will present at least one of the following optional features:
the portion of water is discharged towards a tank supplying the pump with liquid,
the hydraulic circuit includes an intake chamber that defines a volume capable of containing the portion of the liquid,
the intake chamber is positioned between the pump and the boiler,
the intake chamber communicates with the tank,
the hydraulic circuit is equipped with a valve, the opening and closure of which respectively permits and prevents the liquid flow between the intake chamber and the tank,
the hydraulic circuit is arranged so that closure of the valve and pressurising the liquid contained in the said section are synchronised,
the volume defined by the intake chamber is approximately equal to the volume occupied by the portion of liquid,
the hydraulic circuit includes an exit chamber installed between the intake chamber and the boiler,
the exit chamber defines a volume that is approximately equal to the volume occupied by the portion of liquid,
the intake chamber and exit chamber share a common wall with flow between them through a passage created in the wall,
the intake chamber and the exit chamber form a single assembly.

Furthermore, a coffee machine according to the invention, comprising a hydraulic circuit according to any one of the above characteristics, is proposed.

The invention also proposes a process for depressurising a hydraulic circuit for use on machines for making beverages comprising a pump, a boiler and an infusion chamber, the pump being arranged so as to pressurize a liquid contained in a section of the circuit between the pump and the infusion chamber and including the boiler, the process being characterised in that during depressurisation only the portion of the liquid that was not in contact with the boiler when pressurising the liquid is discharged outside the section.

Other characteristics, aims and advantages of the present invention will come to light on reading the detailed description which follows and examining the appended drawings given as nonexhaustive examples.

### FIRST EMBODIMENT

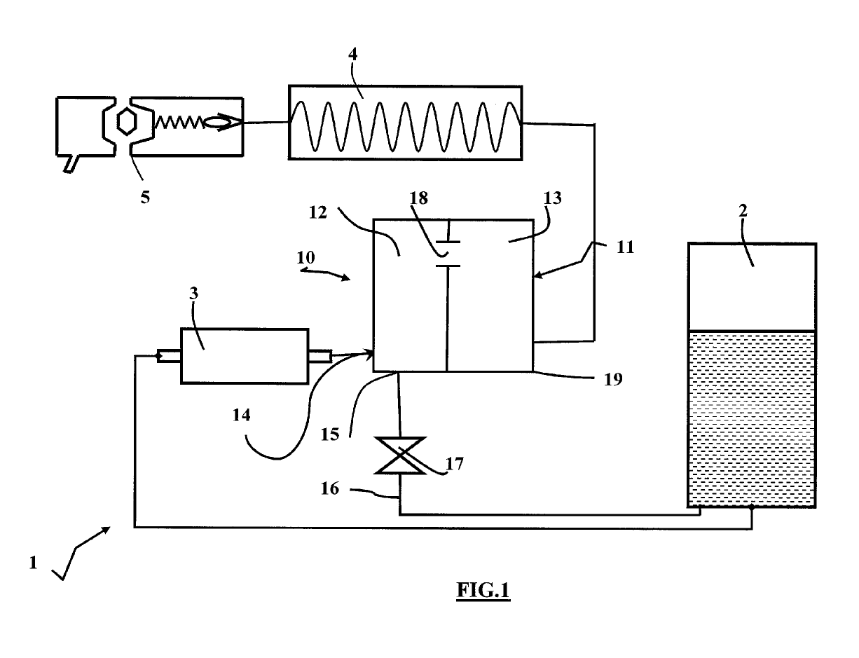

FIG. 1 is a diagram of a hydraulic circuit 1 according to an embodiment of the invention. The embodiment which follows is described with reference to this figure.

This example describes a hydraulic circuit 1 for infusing coffee in pressurised water. Of course, the invention extends to all products that can be infused without being limited to coffee and to all the liquids used to prepare drinks, without being limited to water.

The circuit includes a tank 2, a pump 3, a boiler 4 and an infusion chamber 5 successively from upstream to downstream. In the present application, upstream and downstream are defined relative to the direction of flow of the water in the circuit during infusion.

Thus, the liquid flows between tank 2 pump 3. It is destined to store the water feeding the latter. Pump 3 is positioned between tank 2 and boiler 4. Boiler 4 communicates with pump 3 upstream and infusion chamber 5 downstream. Pump 3 feeds the section of the circuit between pump 3 and infusion chamber 5 with pressurised water. Thus, pump 3 and boiler 4 supply infusion chamber 5 with water at the required pressure and temperature.

The circuit also includes a depressurising device 10. The device includes a cooler 11 acting as intermediate tank. It is installed between pump 3 and boiler 4. Cooler 11 includes an intake chamber 12 and an exit chamber 13 arranged so that the liquid flows between them. Advantageously, this flow takes place through a passage formed in a wall common to both chambers, 12, 13. Thus, cooler 11 forms a single component that is simple to make and incorporate in hydraulic circuit 1.

Intake chamber 12 has an intake connection 14 connected to a pipe carrying the liquid between the exit of pump 3 and intake chamber 12. Intake chamber 12 also has a depressurising connection 15 connected to a depressurising pipe 16 carrying the liquid between intake chamber 12 and tank 2. The circuit also includes a valve arranged on depressurising pipe 16. Advantageously, this valve is a solenoid valve 17.

Closing and opening solenoid valve 17 prevents and permits respectively the liquid to flow between intake chamber 12 and tank 2.

Exit chamber 13 has a discharge connection 19 connected to a pipe carrying the liquid between exit chamber 13 and boiler intake 4.

The operation of this circuit will now be described in detail.

When the user wants to make a drink, coffee, for instance ground or packaged in a pod, is placed in infusion chamber 5. The latter is then sealed and pump 3 is started. Pump 3 injects water from tank 2 into the section of the circuit is between pump 3 and infusion chamber 5.

Water from tank 2 then flows successively through pump 3, intake chamber 12, exit chamber 13, boiler 4 and then reaches infusion chamber 5. Starting pump 3 and therefore injecting pressurised water into the section are synchronised so as to operate on closure of solenoid valve 17.

Thus, solenoid valve 17 remains closed throughout pressurised infusion, thereby preventing the water in intake chamber 12 from escaping through the depressurising connection 15. Before opening the latter, the water contained in the section is pressurised. When preparing beverages of the type Expresso, this pressure is between 8 and 16 bars.

Once infusion has been taken place, coffee production stops and infusion chamber 5 has to be opened. Depressurising device 10 reduces the pressure of the water contained in the section and brings this to a pressure that is close to atmospheric pressure.

Once a drink has been made, pump 3 stopping and solenoid valve 17 opening are actuated simultaneously. This actuation is carried out either manually by an operator pressing on a button or by operating a control lever, or automatically by the hydraulic circuit 1 itself when a certain quantity of water has sufficiently infused the coffee.

Opening solenoid valve 17 allows discharge of the liquid previously maintained under pressure within the section to take place through the depressurising connection 15.

Therefore, opening leads to depressurisation of the section. The pressure of water contained in the section decreases until it balances the pressure of the water held in tank 2. It has to be remembered that the water in tank 2 is at atmospheric pressure.

The water discharged from the section towards depressurising pipe 16 until the pressure balances is hereafter designated “portion of water” and occupies a io volume that is roughly constant on each of the coffee-making cycles.

Intake chamber 12 defines a volume that is roughly equal to the volume occupied by the portion of water. Thus, during the notable depressurisation, all the water contained in intake chamber 12 is discharged through depressurising pipe 16 towards tank 2.

In fact, as intake chamber 12 is fed by pump 3, the water it holds does not stay in boiler 4 during infusion. Consequently, only a portion of the water that has not been in contact with the boiler is discharged outside the section. The temperature of this portion of the water discharged towards tank 2 has not risen.

Therefore, hydraulic circuit 1 according to the invention allows the water discharged outside the section during depressurisation to be recovered at the level of tank 2 without this leading to an increase in the temperature of tank 2.

Thus, the invention eliminates the “bassinelle” and its inherent shortcomings. Therefore, it facilitates maintenance of the coffee machine, considerably limits the appearance of any unpleasant effects caused by the stagnation of water, and prevents any consumption of water in addition to the quantity needed to infuse the coffee.

It also allows tank 2 to be kept at ambient temperature. Thus, no microbial proliferation occurs in the water of tank 2. Moreover, the water in tank 2 remains at a temperature that is low enough not to prejudice the integrity of hydraulic circuit 1 and this even after the many operating cycles that take place continuously. In particular, the temperature of the water supplied to pump 3 will not cause its seals to deteriorate. The temperature of the water supplied to pump 3 also ensures that pump 3 components such as the coil are correctly cooled. As pump 3 is sufficiently cooled, the invention limits the risks of hydraulic circuit 1 drifting.

Moreover, the internal volume of exit chamber 13 is roughly equal to the volume of the portion of water discharged during depressurisation. Thus, when solenoid valve 17 opens, the water in boiler 4 flows back towards this exit chamber 13 and pushes the water contained in the latter into intake chamber 12. The water contained in intake chamber 12 during pressurising is then flushed by the water from exit chamber 13 through depressurising connection 15 in the direction of tank 2.

As a result, and in a particularly advantageous manner, exit chamber 13 acts as an intermediate tank between intake chamber 12 and boiler 4. Therefore, it isolates the water contained in intake chamber 12 while and which is destined to be discharged towards tank 2 on depressurisation from the water which is contained in boiler 4 while maintained under pressure and which is destined to return to cooler 11 on depressurisation. Exit chamber 13 then prevents a portion of the hot water from boiler 4 coming into contact with the water contained in intake chamber 12 and destined to be discharged towards tank 2.

Thus, only the water at ambient temperature in exit chamber 13 when maintained pressurised is able to mix with the hot water from boiler 4 on depressurisation. In fact, this water at ambient temperature, that may be mixed with a little of the hot water, remains inside intake chamber 12 without being discharged towards tank 2 on depressurisation.

Therefore, exit chamber 13 acts as a buffer chamber between boiler 4 and intake chamber 12 and significantly improves the performances of the hydraulic circuit.

During the next beverage making cycle, solenoid valve 17 closes, pump 3 fills intake chamber 12 with water at ambient temperature, under pressure and drawn from tank 2 and flushes the water contained in intake chamber 12 towards exit chamber 13. The hot water contained in exit chamber 13 then returns to boiler 4.

When two beverage making cycles take place within a short space of time, boiler 4 receives the already hot water. This reduces the time of heating and electricity consumption of boiler 4.

### SECOND EMBODIMENT

In a second embodiment, cooler 11 has only one intake chamber 12 and is without exit chamber 13. Intake chamber 12 then communicates with the exit of pump 3, depressurising pipe 16 and boiler 4 intake.

As in the previous example, the inner volume of intake chamber 12 is roughly equal to the volume of the portion of water discharged during depressurisation. Thus, when opening solenoid valve 17, only the water contained in intake chamber 12 maintained under pressure is discharged towards tank 2 during depressurisation. Consequently, during depressurisation, only a portion of the fluid that has not been in contact with boiler 4 on depressurisation is discharged outside the section.

The water that has remained in boiler 4 accumulates in intake chamber 12 and will once again be flushed towards boiler 4 on the next pressurising operation without however being discharged towards tank 2, due to the solenoid valve being closed.

This embodiment overcomes the use of a “bassinelle”. Moreover, it resists an increase in the temperature of the portion of the water discharged into tank 2 and thereby contributes to maintaining the water of the latter at ambient temperature.

Steps may be taken to adapt intake chamber 12 in order to limit any heat exchanges between the water at ambient temperature and the hot water when the latter coming from the boiler penetrates the cooler and flushes the water at ambient temperature towards tank 2. This adaptation of the intake chamber will in particular consist in providing baffles in intake chamber 12 and/or a relative arrangement between depressurising connection 15 and discharge connection 19, and/or a particular shape of the interior of intake chamber 12.

The present invention is not limited to the embodiment described above but extends to any embodiment that conforms to its spirit.

In particular, without leaving the context of the invention, the shapes of each of the two chambers may be varied. Baffles may also be provided inside each chamber. The relative position of each of the chambers and for instance their spacing may also be modified.

### REFERENCES

1. Hydraulic system

2. Tank

3. Pump

4. Boiler

5. Infusion chamber

10. Depressurising device

11. Cooler

12. Intake chamber

13. Exit chamber

14. Intake connection

15. Depressurising connection

16. Depressurising pipe

17. Solenoid valve

18. Passage

19. Discharge connection

1. Hydraulic circuit (1) for use on machines for making beverages comprising a pump (3), a boiler (4), an infusion chamber (5), pump (3) being arranged so as to pressurize a liquid contained in the section of the circuit between pump (3) and infusion chamber (5) and including boiler (4), the circuit including a depressurising device (10) to allow a portion of the liquid to be discharged outside the said section on liquid depressurisation, characterised in that depressurising device (10) is arranged so that only a portion of the liquid that has not been in contact with boiler (4) on liquid pressurisation is discharged outside the section.

2. Circuit according to claim 1, characterised in that the portion of the liquid is discharged towards a tank (2) supplying pump (3) with liquid.

3. Circuit according to claim 1, characterised in that it includes an intake chamber (12) that defines a volume capable of containing the portion of the liquid.

4. Circuit according to claim 3, characterised in that intake chamber (12) is positioned between pump (3) and boiler (4).

5. Circuit according to claim 4, characterised in that intake chamber (12) communicates with tank (2) and is equipped with a valve, the opening and closure of which respectively permits and prevents liquid flow between intake chamber (12) and tank (2).

6. Circuit according to claim 5, characterised in that it is arranged so that closure of the valve and pressurising the liquid contained in the said section are synchronised.

7. Circuit according to claim 3, characterised in that the volume defined by intake chamber (12) is approximately equal to the volume occupied by the portion of liquid.

8. Circuit according to claim 3, characterised in that it includes an exit chamber (13) installed in hydraulic circuit (1) between intake chamber (12) and boiler (4).

9. Circuit according to claim 8, characterised in that exit chamber (13) defines a volume that is approximately equal to the volume occupied by the portion of the liquid.

10. Circuit according to claim 8, characterised in that intake chamber (12) and exit chamber (13) share a common wall with flow between them through a passage created in the wall.

11. Coffee machine with a hydraulic circuit according to claim 1.

12. Process for depressurising a hydraulic circuit (1) for use on machines for making beverages comprising a pump (3), a boiler (4), an infusion chamber (5), pump (3) being arranged so as to pressurize a liquid contained in a section of the circuit between pump (3) and infusion chamber (5) and including boiler (4), characterised in that during depressurisation only the portion of the liquid that has not been in contact with the boiler (4) when pressurising the liquid is discharged outside the section.
